(19) United States
(12) Patent Application Publication
(10) Pub. No.: US 2021/0334461 A1
(43) Pub. Date: Oct. 28, 2021

(54) ARTIFICIAL INTELLIGENCE APPARATUS AND METHOD FOR GENERATING NAMED ENTITY TABLE

(71) Applicant: LG ELECTRONICS INC., Seoul (KR)

(72) Inventors: Jonghoon CHAE, Seoul (KR); Jiwoo SEO, Seoul (KR)

(73) Assignee: LG ELECTRONICS INC., Seoul (KR)

(21) Appl. No.: 16/604,428

(22) PCT Filed: Aug. 30, 2019
(86) PCT No.: PCT/KR2019/011208

§ 371 Date: Oct. 10, 2019

(51) Int. Cl. G06F 40/295; G06N 3/08; G06F 40/268; G06F 16/383

(52) U.S. Cl. CPC G06F 40/295; G06F 16/383; G06F 40/268; G06N 3/08

(57) ABSTRACT

According to an embodiment of the present disclosure, there is provided an artificial intelligence apparatus for generating a named entity table, the artificial intelligence apparatus including: a memory configured to store a first text, first metadata, and a first named entity table, which correspond to each of a plurality of first domains; and a processor configured to: learn a named entity table generation model using the stored first text, the stored first metadata, and the stored first named entity table, and generate a second named entity table corresponding to a second text and second metadata of a second domain different from the plurality of first domains, using the learned named entity table generation model.

### TECHNICAL FIELD

The present disclosure relates to an artificial intelligence apparatus and a method for generating a named entity table. Specifically, the present disclosure relates to an artificial intelligence apparatus and method for generating a named entity table in a new domain using existing named entity tables.

### BACKGROUND ART

Named entities mean words or phrases that have a specific meaning within a given text, and have a great influence in determining the meaning of the text. Therefore, in natural language processing, it is important to correctly recognize (or extract) a named entity from the text. Since there are different proper nouns and homonyms according to the characteristics of each domain, named entity recognition (NER) is performed by using a named entity table that is divided for each domain.

However, in order to construct the named entity table, the named entity tag is set for each word included in the input text as well as the domain of the input text. Therefore, even when configuring the named entity table for the new domain, the user should set the domain of the newly input text and the named entity tag for each word without using the named entity table in another existing domain. Accordingly, there is a problem that a lot of human resources are required.

### DISCLOSURE

### Technical Problem

The present disclosure provides an artificial intelligence apparatus and method for generating a named entity table in a new domain by using a named entity table generated for another domain.

### Technical Solution

According to an embodiment of the present disclosure, there is provided an artificial intelligence apparatus which learn a named entity table generation model using a first text, first metadata, and a first named entity table, corresponding to each of a plurality of first domains, and generate a second named entity table corresponding to a second text and second metadata of a second domain different from the plurality of first domains, using the learned named entity table generation model; and a method of the same.

### Advantageous Effect

According to various embodiments of the present disclosure, a named entity table for a new domain may be easily generated with less human resources by using a named entity table generated for another domain. In other words, unlike the conventional method for generating a named entity table, since the user does not have to manually perform a named entity tag for each morpheme or word, a named entity table for a new domain can be easily generated.

### DESCRIPTION OF DRAWINGS

FIG. 1 is a block diagram illustrating an AI apparatus according to an embodiment of the present disclosure.

FIG. 2 is a block diagram illustrating an AI server according to an embodiment of the present disclosure.

FIG. 3 is a view illustrating an AI system according to an embodiment of the present disclosure.

FIG. 4 is a block diagram illustrating an AI apparatus according to an embodiment of the present disclosure.

FIG. 5 is a flowchart illustrating a method of generating a named entity table according to an embodiment of the present disclosure.

FIG. 6 is a view illustrating a method of learning a named entity table generation model according to an embodiment of the present disclosure.

FIG. 7 is a diagram illustrating a method of generating a named entity table according to an embodiment of the present disclosure.

FIG. 8 is a view illustrating an example of a named entity table generation model according to an embodiment of the present disclosure.

### MODE FOR CARRYING OUT THE INVENTION

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

<Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for training data is given, and the label may mean the correct answer (or result value) that the artificial neural network must infer when the training data is input to the artificial neural network. The unsupervised learning may refer to a method of learning an artificial neural network in a state in which a label for training data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

<Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

<Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

Here, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

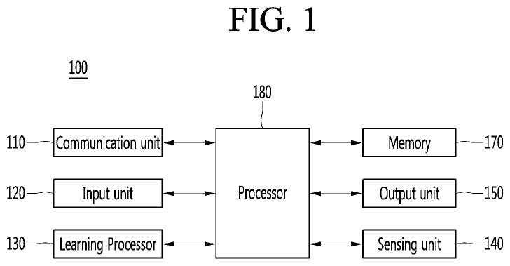

FIG. 1 is a block diagram illustrating an AI apparatus 100 according to an embodiment of the present disclosure.

Hereinafter, the AI apparatus 100 may be referred to as a terminal.

The AI apparatus (or an AI device) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI apparatus 100 may include a communication unit 110, an input unit 120, a learning processor 130, a sensing unit 140, an output unit 150, a memory 170, and a processor 180.

The communication unit 110 may transmit and receive data to and from external devices such as other 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth'TM, RFID (Radio Frequency Identification), Infrared Data Association (IrDA), ZigBee, NFC (Near Field Communication), and the like.

The input unit 120 may acquire various kinds of data. Here, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a training data for model learning and an input data to be used when an output is acquired by using learning model. The input unit 120 may acquire raw input data. Here, the processor 180 or the learning processor 130 may extract an input feature by preprocessing the input data.

The learning processor 130 may learn a model composed of an artificial neural network by using training data. The learned artificial neural network may be referred to as a learning model. The learning model may be used to an infer result value for new input data rather than training data, and the inferred value may be used as a basis for determination to perform a certain operation.

Here, the learning processor 130 may perform AI processing together with the learning processor 240 of the AI server 200.

Here, the learning processor 130 may include a memory integrated or implemented in the AI apparatus 100. Alternatively, the learning processor 130 may be implemented by using the memory 170, an external memory directly connected to the AI apparatus 100, or a memory held in an external device.

The sensing unit 140 may acquire at least one of internal information about the AI apparatus 100, ambient environment information about the AI apparatus 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

Here, the output unit 150 may include a display unit for outputting time information, a speaker for outputting auditory information, and a haptic module for outputting haptic information.

The memory 170 may store data that supports various functions of the AI apparatus 100. For example, the memory 170 may store input data acquired by the input unit 120, training data, a learning model, a learning history, and the like.

The processor 180 may determine at least one executable operation of the AI apparatus 100 based on information determined or generated by using a data analysis algorithm or a machine learning algorithm. The processor 180 may control the components of the AI apparatus 100 to execute the determined operation.

To this end, the processor 180 may request, search, receive, or utilize data of the learning processor 130 or the memory 170. The processor 180 may control the components of the AI apparatus 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI apparatus 100 so as to drive an application program stored in memory 170. Furthermore, the processor 180 may operate two or more of the components included in the AI apparatus 100 in combination so as to drive the application program.

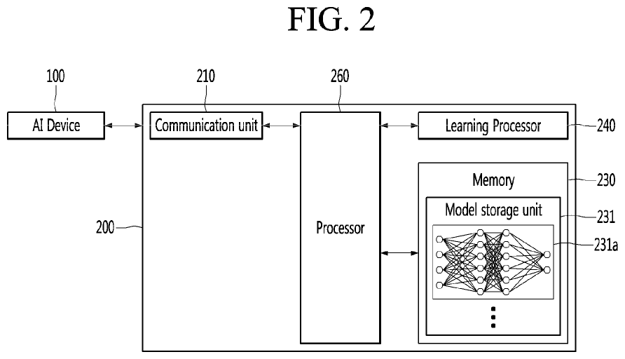

FIG. 2 is a block diagram illustrating an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. Here, the AI server 200 may be included as a partial configuration of the AI apparatus 100, and may perform at least part of the AI processing together.

The AI server 200 may include a communication unit 210, a memory 230, a learning processor 240, a processor 260, and the like.

The communication unit 210 can transmit and receive data to and from an external device such as the AI apparatus 100.

The memory 230 may include a model storage unit 231. The model storage unit 231 may store a learning or learned model (or an artificial neural network 231a) through the learning processor 240.

The learning processor 240 may learn the artificial neural network 231a by using the training data. The learning model may be used in a state of being mounted on the AI server 200 of the artificial neural network, or may be used in a state of being mounted on an external device such as the AI apparatus 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

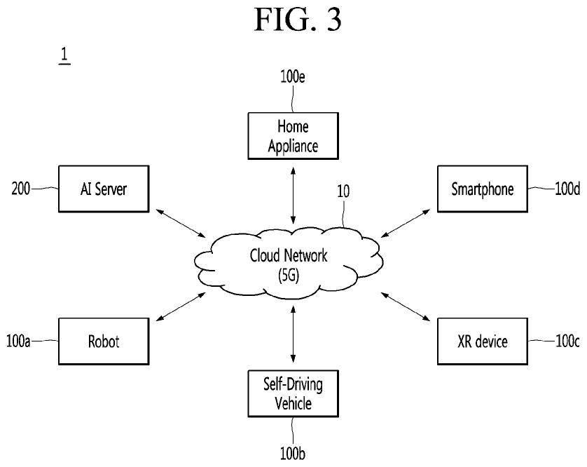

FIG. 3 is a view illustrating an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI apparatuses 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

In other words, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI apparatuses constituting the AI system 1, that is, the robot 100a, the self-driving vehicle 100b, the XR device 100c, the smartphone 100d, or the home appliance 100e through the cloud network 10, and may assist at least part of AI processing of the connected AI apparatuses 100a to 100e.

Here, the AI server 200 may learn the artificial neural network according to the machine learning algorithm instead of the AI apparatuses 100a to 100e, and may directly store the learning model or transmit the learning model to the AI apparatuses 100a to 100e.

Here, the AI server 200 may receive input data from the AI apparatuses 100a to 100e, may infer the result value for the received input data by using the learning model, may generate a response or a control command based on the inferred result value, and may transmit the response or the control command to the AI apparatuses 100a to 100e.

Alternatively, the AI apparatuses 100a to 100e may infer the result value for the input data by directly using the learning model, and may generate the response or the control command based on the inference result.

Hereinafter, various embodiments of the AI apparatuses 100a to 100e to which the above-described technology is applied will be described. The AI apparatuses 100a to 100e illustrated in FIG. 3 may be regarded as a specific embodiment of the AI apparatus 100 illustrated in FIG. 1.

<AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

Here, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. Here, the robot 100a may acquire the intention information of the interaction due to the user's operation or speech utterance, and may determine the response based on the acquired intention information, and may perform the operation.

<AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling route by using the recognized surrounding information or object information. The learning model may be learned directly from the self-driving vehicle 100a or may be learned from an external device such as the AI server 200.

Here, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external device to determine the travel route and the travel plan, and may control the driving unit such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving unit based on the control/interaction of the user. Here, the self-driving vehicle 100b may acquire the intention information of the interaction due to the user's operation or speech utterance, and may determine the response based on the acquired intention information, and may perform the operation.

<AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

Here, the XR device 100c may perform the operation by generating the result by directly using the learning model, but the sensor information may be transmitted to the external device such as the AI server 200 and the generated result may be received to perform the operation.

<AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given route without the user's control or moves for itself by determining the route by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

Here, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

<AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

<AI+Self-Driving+XR>

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

Here, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

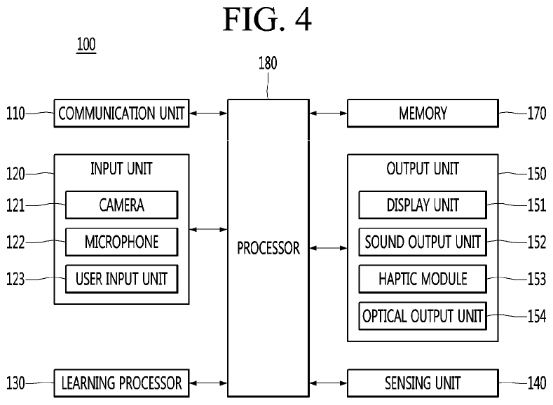

FIG. 4 is a block diagram illustrating an AI apparatus 100 according to an embodiment of the present disclosure.

The redundant repeat of FIG. 1 will be omitted below. Referring to FIG. 4, the input unit 120 may include a camera 121 for image signal input, a microphone 122 for receiving audio signal input, and a user input unit 123 for receiving information from a user.

Voice data or image data collected by the input unit 120 are analyzed and processed as a user's control command.

Then, the input unit 120 is used for inputting image information (or signal), audio information (or signal), data, or information inputted from a user and the AI apparatus 100 may include at least one camera 121 in order for inputting image information.

The camera 121 processes image frames such as a still image or a video obtained by an image sensor in a video call mode or a capturing mode. The processed image frame may be displayed on the display unit 151 or stored in the memory 170.

The microphone 122 processes external sound signals as electrical voice data. The processed voice data may be utilized variously according to a function (or an application program being executed) being performed in the AI apparatus 100. Moreover, various noise canceling algorithms for removing noise occurring during the reception of external sound signals may be implemented in the microphone 122.

The user input unit 123 is to receive information from a user and when information is inputted through the user input unit 123, the processor 180 may control an operation of the AI apparatus 100 to correspond to the inputted information.

The user input unit 123 may include a mechanical input means (or a mechanical key, for example, a button, a dome switch, a jog wheel, and a jog switch at the front, back or side of the AI apparatus 100) and a touch type input means. As one example, a touch type input means may include a virtual key, a soft key, or a visual key, which is displayed on a touch screen through software processing or may include a touch key disposed at a portion other than the touch screen.

The sensing unit 140 may also be referred to as a sensor unit.

The output unit 150 may include at least one of a display unit 151, a sound output module 152, a haptic module 153, or an optical output module 154.

The display unit 151 may display (output) information processed in the AI apparatus 100. For example, the display unit 151 may display execution screen information of an application program running on the AI apparatus 100 or user interface (UI) and graphic user interface (GUI) information according to such execution screen information.

The display unit 151 may be formed with a mutual layer structure with a touch sensor or formed integrally, so that a touch screen may be implemented. Such a touch screen may serve as the user input unit 123 providing an input interface between the AI apparatus 100 and a user, and an output interface between the AI apparatus 100 and a user at the same time.

The sound output module 152 may output audio data received from the wireless communication unit 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the AI apparatus 100. An example of an event occurring in the AI apparatus 100 includes message reception, call signal reception, missed calls, alarm, schedule notification, e-mail reception, and information reception through an application.

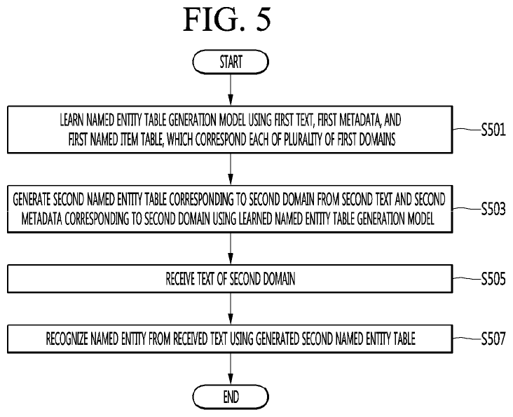

FIG. 5 is a flowchart illustrating a method of generating a named entity table according to an embodiment of the present disclosure.

As described above, in order to correctly recognize the meaning or intention of a given text, it is important to correctly recognize a named entity included in the text. The named entity is a noun type such as a proper noun and a noun phrase.

Named entity recognition (NER) means recognizing (or determining) the named entity tag of the named entity contained in the text. In other words, named entity recognition includes identifying a named entity included in the text and determining a tag of the identified named entity. The named entity recognition may be performed using a named entity table corresponding to a given domain. The named entity table may include each named entity and a tag corresponding to the named entity.

The domain may mean a field in which named entity recognition is performed and may be divided into various units such as a product unit, a technology unit, and a service unit. For example, the domain may include a food domain, a sports domain, a weather domain, a music domain, a movie domain, an information technology (IT) domain, a medical domain, and the like.

The named entity table may be referred to as a named entity recognition model in that the named entity table includes each named entity and a tag corresponding thereto and recognizes the named entity using the named entity table.

Conventionally, in order to generate a named entity table for a new domain, a person has to specify a corresponding tag for each named entity included in the given text. In other words, there is a problem in that a lot of human effort is involved every time the named entity table for a new domain is generated.

Referring to FIG. 5, a processor 180 or a learning processor 130 of the artificial intelligence apparatus 100 learns a named entity table generation model using a first text, first metadata, and a first named entity table corresponding to each of the plurality of first domains (S501).

The plurality of first domains may refer to domains corresponding to each of the generated named entity tables. The first domain may be referred to as a base domain. Similarly, the first text may be referred to as base text, the first metadata may be referred to as base metadata, and the first named entity table may be referred to as a base named entity table.

The first text, the first metadata, and the first named entity table may mean a text, metadata, and named entity table corresponding to each of the plurality of first domains. In other words, when the plurality of first domains are n domains, the first text, the first metadata, and the first named entity table exist by n, respectively, which correspond to one of the n first domains. For example, when the first domains are a sports domain and a music domain, the first text includes the sports domain text and the music domain text, the first metadata includes the sports domain metadata and the music domain metadata, and the first named entity table may include a sports domain named entity table and a music domain named entity table.

The first text may include many sentences and words. In addition, the first text may be represented as the text itself or may be expressed as ASCII code or Unicode corresponding to the first text, and the first text may be represented as a word vector converted from the first text according to a word embedding technique. For example, the processor 180 may convert the first text into a word vector according to the word embedding technique.

The first metadata is metadata corresponding to the first text and may include information that can be used to recognize the named entity from the first text. The first metadata may include at least one of domain information corresponding to the first text, action/function information that an agent may perform in a domain corresponding to the first text, part-of-speech information of each morpheme contained in the first text, or size information of the named entity table. In particular, the first metadata may essentially include domain information. For example, the action/function information may include search, play, guide, and the like. The size information of the named entity table may mean the number of named entity tags included in the named entity table. The first metadata may be set by a user or an administrator. In one embodiment, the part-of-speech information may be automatically set based on part-of-speech tagging (POS tagging) technique.

Each of the domain information, action/function information, and size information may be set singularly in one domain, and the part-of-speech information may be set for each morpheme of text even in one domain.

The first named entity table may be generated using the first text and the first metadata and may include a named entity that can be used to recognize the named entity from the first text and a named entity tag corresponding thereto. The first named entity table may include a positive named entity table and a negative named entity table. The positive named entity table is a named entity table including a morpheme or word to be recognized as a named entity and a named entity tag corresponding thereto, and the negative named entity table may mean a named entity table including a morpheme or word not to be recognized as a named entity. In other words, the positive named entity table may mean that a specific morpheme or word belongs to a domain, and the negative named entity table may mean that a specific morpheme or word does not belong to a domain. The negative named entity table can be used as a filter when recognizing named entity from text.

The named entity table includes a named entity tag corresponding to each of the morphemes or words included in the input text, and in this respect, the named entity table nay include a positive named entity table. In addition, the named entity table may include not only the named entity tag but also a tag (for example, a negative tag) indicating a negative named entity table and a negative tag may be stored corresponding to a portion of morphemes or words included in the input text. In this respect, the named entity table also includes a negative named entity table. In other words, even if there is a single named entity table, if a named entity tag or a negative tag is selectively mapped to a morpheme or word, the named entity table may be considered to include both a positive named entity table and a negative named entity table.

The set of the first text, the first metadata, and the first named entity table corresponding to the same domain may constitute one training data. The processor 180 or the learning processor 130 may learn the named entity table generation model using the plurality of training data. The memory 170 may store training data for learning the named entity table generation model. In other words, the memory 170 may store the first text, the first metadata, and the first named entity table corresponding to each of the plurality of first domains.

The named entity table generation model includes an artificial neural network and may be learned using a machine learning algorithm or a deep learning algorithm. For example, the named entity table generation model may include a recurrent neural network (RNN), a bidirectional RNN (BRNN), a long short-term memory (LSTM), or a bidirectional LSTM (BiLSTM).

The named entity table generation model is a model for outputting a named entity table corresponding to the first domain, when the first text and the first metadata corresponding to the first text of the first domain included in the training data is input. The first named entity table included in the training data may be used as label data used for learning the named entity table generation model.

Specifically, the processor 180 or the learning processor 130 extracts an input feature vector from the first text and the first metadata included in the training data, and inputs the extracted input feature vector to the input layer of the named entity table generation model, and in response, acquires the named entity table output from the extraction layer of the named entity table generation model. The processor 180 or the learning processor 130 updates the named entity table generation model so as to calculate an error between the named entity table acquired from the named entity table generation model and the first named entity table included in the training data, and to reduce the calculated error, and thus allows the named entity table generation model to be learned. In other words, the named entity table generation model may learn so that the named entity table generated from the first text and the first metadata included in the training data follows the first named entity table included in the training data. Accordingly, the well-learned named entity table generation model may generate and output a named entity table that is identical or very similar to the first named entity table included in the training data from the first text and the first metadata included in the training data. The memory 170 may store the learned named entity table generation model.

Then, the processor 180 of the artificial intelligence apparatus 100 uses the learned named entity table generation model to generate a second named entity table corresponding to the second domain from the second text and the second metadata corresponding to the second domain (S503).

The second domain may mean a new domain different from the first domain, and in particular, may mean a domain in which the named entity table is not generated. The second domain may be referred to as a target domain. Similarly, the second text may be referred to as target text, the second metadata may be referred to as target metadata, and the second named entity table may be referred to as a target named entity table.

Like the first text, the second text may include many sentences and words. In addition, the second text may be represented as the text itself as an ASCII code or Unicode corresponding to the second text, or as a word vector converted from the second text according to a word embedding technique. For example, the processor 180 may convert the second text into a word vector according to a word embedding technique.

The second text is preferably expressed in the same format as the first text. If the second text has a different format from the first text, the processor 180 may change the format of the second text to be the same as that of the first text. The memory 170 may store the second text.

Like the first metadata, the second metadata is metadata corresponding to the second text and may include information that can be used to recognize the named entity from the second text. The second metadata may include at least one of domain information corresponding to the second text, action/function information that an agent may perform in the domain corresponding to the second text, part-of-speech information included in the second text, or the size information of the named entity table. In particular, the second metadata may essentially include domain information. For example, action/function information may include search, playback, guidance, and the like. The size information of the named entity table may mean the number of named entity tags included in the named entity table. The second metadata may be set by a user or an administrator. In one embodiment, the part-of-speech information may be automatically set based on the part-of-speech tagging technique. The memory 170 may store the second metadata.

The named entity table generation model has already been learned using a plurality of training data corresponding to a plurality of first domains and in the already learned domain, if a text and metadata corresponding to the text are given, outputs the named entity table corresponding to the domain. In other words, the named entity table generation model learns the relationship between the text, the metadata, and the named entity table. Therefore, the processor 180 inputs the second text and the second metadata in the second domain different from the first domains to the named entity table generation model, thereby acquiring a second named entity table corresponding to the second domain output from the named entity table generation model. The memory 170 may store the generated second named entity table.

Similar to the first named entity table, the second named entity table is generated using the second text and the second metadata, and can include a named entity and a named entity tag corresponding thereto that can be used to recognize the named entity from the second text. The second named entity table may include a positive named entity table and a negative named entity table.

The second named entity table generated by the named entity table generation model may include only entity tags as many as the number according to the size information of the named entity table included in the second metadata. If the size information of the named entity table is not included in the second metadata, the named entity table generation model may determine an appropriate number of named entity tags based on a result of learning about the first domain.

Unlike the first domain, the named entity table generation model generates a second named entity table without setting a named entity tag for each named entity included in the second text. Thus, the second named entity table may be different from the named entity table set or generated by the user. However, since the named entity table generation model generates the named entity table (second named entity table) in the new domain (second domain) based on the generation rules of the named entity table (first named entity table) for other domains (first domains), the generated second named entity table may be expected to have significant reliability, although not perfect. Furthermore, the second named entity table generated using the named entity table generation model may be used as an initial setting or an initial value when the user generates a named entity table in the second domain.

The processor 180 of the artificial intelligence apparatus 100 receives the text of the second domain through the communication unit 110 or the input unit 120 (S505).

The processor 180 may receive the text of the second domain from an external device such as a user terminal through the communication unit 110, and receive the text of the second domain from a keyboard, a mouse, a microphone, or the like through the input unit 120.

If the format of the received data is not text, the processor 180 may convert the format of the received data into text. For example, when a user speaks a voice for a second domain using a microphone, the processor 180 may convert the received voice data into text.

Information that the received text is the second domain may be determined based on user input. For example, when the second domain is a sports domain and the user inputs text for recognizing named entity while setting the domain as the sports domain, the processor 180 may determine that the input text is the text of the sports domain. In this case, the processor 180 may receive the text of the second domain together with the information that the text is the second domain.

The processor 180 of the artificial intelligence apparatus 100 recognizes the named entity from the received text by using the generated second named entity table (S507).

Since the second named entity table stores pairs of named entity and named entity tags corresponding to the second domain, the processor 180 may recognize the named entity in the received text by using the generated second named entity table. As described above, recognizing a named entity may mean recognizing or identifying a named entity included in the text and a named entity tag of the named entity.

According to the above-described steps (S501 to S507), the artificial intelligence apparatus 100 can generate the named entity table in the new domain, and further recognize the named entity from the text of the new domain.

According to an embodiment of the present disclosure, only the step of generating the named entity table generation model (S501) and the step of generating the second named entity table (S503) are performed, and accordingly, the artificial intelligence apparatus 100 may generate only the named entity table in a new domain.

FIG. 5 illustrates a process of generating a named entity table in a new domain by using the artificial intelligence apparatus 100 as a subject, but, the present disclosure is not limited thereto. In other words, in one embodiment of the present disclosure, the artificial intelligence server 200 may generate the named entity table in the new domain, the artificial intelligence apparatus 100 may receive the named entity table generated from the artificial intelligence server 200 and recognize the named entity from the text of the new domain using the received named entity table.

In addition, according to an embodiment of the present disclosure, the artificial intelligence server 200 may generate the named entity table in the new domain, receive the text of the new domain from the artificial intelligence apparatus 100, recognize the named entity in the text of the new domain using the generated named entity table, and transmit the recognized named entity to the artificial intelligence apparatus 100.

If the artificial intelligence server 200 generates the named entity table corresponding to the new domain, the processor 260 or the learning processor 240 of the artificial intelligence server 200 may learn the named entity table generation model, and the processor 260 may generate a named entity table corresponding to the new domain using the learned named entity table generation model.

Description of a method for generating a named entity table corresponding to a new domain by an artificial intelligence server 200 is the same as the method for generating the named entity table corresponding to the new domain by the artificial intelligence apparatus 100 illustrated in FIG. 5, and thus redundant description is omitted.

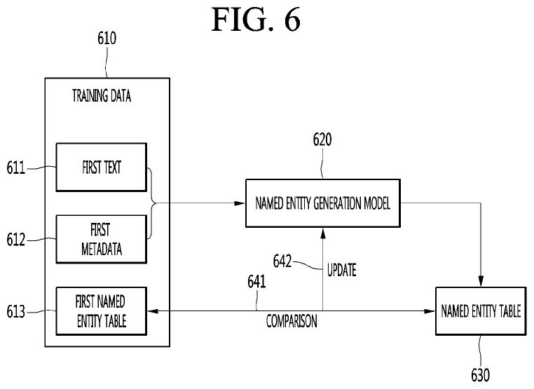

FIG. 6 is a view illustrating a method of learning a named entity table generation model according to an embodiment of the present disclosure.

Referring to FIG. 6, the training data 610 may include a first text 611, a first metadata 612, and a first named entity table 613 corresponding to the first domain.

The first text 611 and the first metadata 612 of the training data 610 are input to the named entity table generation model 620. An input feature vector may be extracted from the first text 611 and the first metadata 612, and the extracted input feature vector may be input to an input layer of the named entity table generation model 620.

The named entity table generation model 620 outputs a named entity table corresponding to the first text 611 and the first metadata 612 based on the input first text 611 and the first metadata 612.

The output (or generated) named entity table 630 is compared 641 with the first named entity table 613 included in the training data 610 and based on the comparison result, the update 642 the named entity table generation model 620 is performed. The update 642 of the named entity table generation model 620 is made such that the difference between the first named entity table 613 and the generated named entity table 630 is reduced. In other words, the named entity table generation model 620 is learned so that the output named entity table 630 follows the first named entity table 613 included in the training data 610.

The method illustrated in FIG. 6 illustrates one cycle of a method of learning the named entity table generation model 620, and this process may be repeatedly performed.

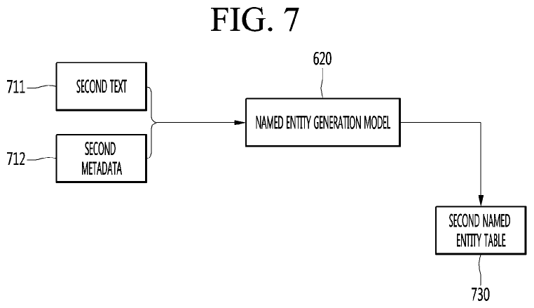

FIG. 7 is a diagram illustrating a method of generating a named entity table according to an embodiment of the present disclosure.

Referring to FIG. 7, the second text 711 and the second metadata 712 corresponding to the second domain not used for learning the named entity table generation model 620 are input to the named entity table generation model 620. The named entity table generation model 620 may be learned according to the method illustrated in FIG. 6.

In addition, the named entity table generation model 620 may output a second name entity table 730 corresponding to the second text 711 and the second metadata 712 based on the input second text 711 and the second metadata 712. The output (or generated) second named entity table may be used as the named entity table corresponding to the second domain.

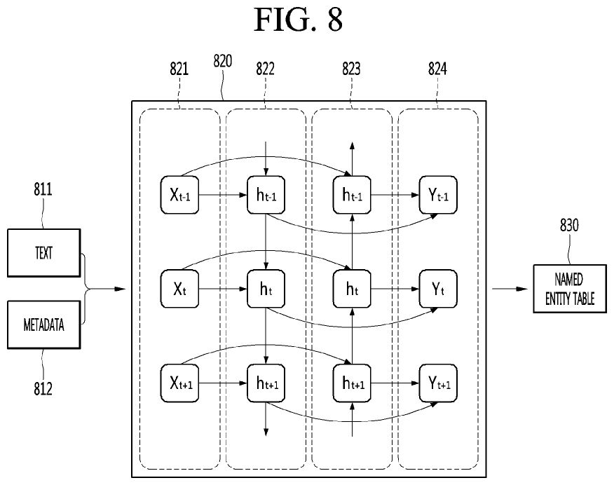

FIG. 8 is a view illustrating an example of a named entity table generation model according to an embodiment of the present disclosure.

Referring to FIG. 8, text 811 and metadata 812 in a domain for generating a named entity table are input to a named entity table generation model 820. The named entity table generation model 820 may include a bidirectional long short-term memory BiLSTM. The named entity table generation model 820 may include an input layer 821, a forward layer 822, a backward layer 823, and an output layer 824.

The named entity table generation model outputs a named entity table 830 corresponding to the input text 811 and the metadata 812.

As described above, the named entity table 830 may include a positive named entity table and a negative named entity table. Here, the meaning that the named entity table 830 includes the positive named entity table and the negative named entity table may include a meaning that the named entity table generation model 820 generates the positive named entity table and the negative named entity table separately from each other and a meaning that the named entity table generation model 820 generates a single named entity table that includes the functions of a positive named entity table and a negative named entity table.

According to an embodiment of the present disclosure, the above-described method may be implemented as a processor-readable code in a medium where a program is recorded. Examples of a processor-readable medium may include hard disk drive (HDD), solid state drive (SSD), silicon disk drive (SDD), read-only memory (ROM), random access memory (RAM), CD-ROM, a magnetic tape, a floppy disk, and an optical data storage device.

1. An artificial intelligence apparatus for generating a named entity table, the artificial intelligence apparatus comprising:
a memory configured to store a first text, first metadata, and a first named entity table, which correspond to each of a plurality of first domains; and
a processor configured to:
learn a named entity table generation model using the stored first text, the stored first metadata, and the stored first named entity table, and
generate a second named entity table corresponding to a second text and second metadata of a second domain different from the plurality of first domains, using the learned named entity table generation model.

2. The artificial intelligence apparatus of claim 1,
wherein each of the first named entity table and the second named entity table includes a positive named entity table and a negative named entity table,
wherein the positive named entity table includes a named entity to be recognized in the corresponding domain and a named entity tag corresponding to the named entity to be recognized, and
wherein the negative named entity table includes a named entity that will not be recognized in the corresponding domain.

3. The artificial intelligence apparatus of claim 1,
wherein the named entity table generation model includes an artificial neural network (ANN) and is learned using a machine learning algorithm or a deep learning algorithm.

4. The artificial intelligence apparatus of claim 3,
wherein the named entity table generation model includes at least one of a recurrent neural network (RNN), a bidirectional RNN (BRNN), a long short-term memory (LSTM), or a bidirectional LSTM (BiLSTM).

5. The artificial intelligence apparatus of claim 3,
wherein the processor is configured to:
extract an input feature vector corresponding to the named entity table generation model from the stored first text and the stored first metadata,
input the extracted input feature vector to the named entity table generation model,
acquire the named entity table outputted from the named entity table generation model,
calculate a difference between the acquired named entity table and the stored first named entity table, and
update the named entity table generation model so as to reduce the calculated difference.

6. The artificial intelligence apparatus of claim 1,
wherein the memory is configured to store the second text and the second metadata.

7. The artificial intelligence apparatus of claim 1,
wherein the processor is configured to convert each of the first text and the second text into a word vector using a word embedding technique.

8. The artificial intelligence apparatus of claim 1,
wherein the first metadata includes domain information corresponding to the first text, and
wherein the second metadata includes domain information corresponding to the second text.

9. The artificial intelligence apparatus of claim 8,
wherein the first metadata further includes at least one of action/function information that can be performed by an agent in a domain corresponding to the first text, part-of-speech information of each morpheme included in the first text, or size information of the named entity table, and
wherein the second metadata further includes at least one of the action/function information that can be performed by the agent in a domain corresponding to the second text, part-of-speech information of each morpheme included in the second text, or size information of the named entity table.

10. The artificial intelligence apparatus of claim 9,
wherein each of the first metadata and the second metadata is set automatically based on a POS tagging technique.

11. The artificial intelligence apparatus of claim 1,
wherein the processor is configured to receive a text of the second domain and recognize a named entity included in the received text using the second named entity table.

12. The artificial intelligence apparatus of claim 11,
wherein the processor is configured to convert the received text into the same format as a format of the second text, if the format of the received text is different from the format of the second text.

13. A method for generating a named entity table, the method comprising:
learning a named entity table generation model using a first text, first metadata, and a first named entity table, which correspond to each of a plurality of first domains; and
generating a second named entity table corresponding to a second text and second metadata of a second domain different from the plurality of first domains by using the learned named entity table generation model.

14. A recording medium in which a program for executing a method for generating a named entity table is recorded,
wherein the method for generating a named entity table comprising:
learning a named entity table generation model using a first text, first metadata, and a first named entity table, which correspond to each of a plurality of first domains; and
generating a second named entity table corresponding to a second text and second metadata of a second domain different from the plurality of first domains by using the learned named entity table generation model.
